(19) United States
(12) Patent Application Publication
(10) Pub. No.: US 2026/0030531 A1
(43) Pub. Date: Jan. 29, 2026

(54) VISUALIZING INFORMATION REGARDING BOTH A QUANTUM CIRCUIT AND A QUANTUM DEVICE UPON WHICH THE QUANTUM CIRCUIT IS EXECUTED

(71) Applicant: International Business Machines Corporation, Armonk, NY (US)

(72) Inventors: Derek Wang, New York, NY (US); Alireza Seif Tabrizi, Adelphi, MD (US)

(21) Appl. No.: 18/787,129

(22) Filed: Jul. 29, 2024

(51) Int. Cl. G06N 10/20; G06N 10/40

(52) U.S. Cl. CPC G06N 10/20; G06N 10/40

(57) ABSTRACT

A method, system, and computer program product for visualizing information regarding both a quantum circuit and a quantum device. A qubit architecture (e.g., two-dimensional qubit architecture) of the quantum circuit is displayed depicting operational characteristics of the quantum device in a first circuit layer. Furthermore, one or more images of the qubit architecture of the quantum circuit are displayed as being propagated along a third dimension axis across one or more circuit layers plotted with circuit instructions. Additionally, an image of the qubit architecture of the quantum circuit is displayed in a final circuit layer depicting measurement information about the quantum circuit and the quantum device. In this manner, information about both the quantum circuit and the quantum device upon which it is executed may be effectively visualized.

### TECHNICAL FIELD

The present disclosure relates generally to quantum visualization tools, and more particularly to visualizing information regarding both a quantum circuit and a quantum device upon which the quantum circuit is executed.

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

Current quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation and quantum error correction techniques have been developed. Quantum error mitigation refers to mitigating computation errors while keeping the hardware load to a minimum. Quantum error correction refers to a set of techniques used in quantum computing to protect quantum information from errors due to decoherence and other quantum noise.

However, such techniques involves overhead, which should be minimized. As a result, quantum computations should be executed with minimal noise to minimize the overhead of quantum error mitigation and quantum error correction techniques.

Various strategies exist for executing quantum computations with minimal noise. One strategy is to map a quantum circuit to a particular quantum device, typically constrained only by the native connectivity and the gate set.

Another strategy is to utilize an algorithm, such as “mapomatic,” where a quantum device is mapped to a particular quantum circuit, typically based on the operational characteristics of the quantum device (e.g., two-qubit gates, measurement errors, etc.).

Developing such complex strategies requires tools for visualization and manipulation, but the challenge is that such tools do not exist. For example, there is not currently a means for visualizing quantum circuits on a quantum device with operational characteristics. Instead, at best, operational characteristics may be shown with quantum circuits on nearest-neighbor one-dimensional (1D) chains.

As a result, there is not currently a means for effectively visualizing information about both the quantum circuit and the quantum device upon which it is executed.

### SUMMARY

In one embodiment of the present disclosure, a method for visualizing information regarding both a quantum circuit and a quantum device comprises displaying a qubit architecture of the quantum circuit depicting operational characteristics of the quantum device. The method further comprises displaying one or more images of the qubit architecture of the quantum circuit propagated along a third dimension axis across one or more circuit layers plotted with circuit instructions.

Furthermore, in one embodiment of the present disclosure, the qubit architecture of the quantum circuit depicting operational characteristics of the quantum device is displayed in a first circuit layer.

Additionally, in one embodiment of the present disclosure, the method further comprises displaying an image of the qubit architecture of the quantum circuit in a final circuit layer depicting measurement information about the quantum circuit and the quantum device.

Furthermore, in one embodiment of the present disclosure, the nodes in the final circuit layer are labeled to indicate measurement basis information, where edges in the final circuit layer are labeled to indicate measurement error information.

Additionally, in one embodiment of the present disclosure, the nodes of the qubit architecture of the quantum circuit are qubits, where edges of the qubit architecture of the quantum circuit indicate connectivity between the qubits.

Furthermore, in one embodiment of the present disclosure, one or more of the nodes are labeled to indicate a property of the qubits, where one or more of the edges are labeled to indicate a property of gates.

Additionally, in one embodiment of the present disclosure, an edge that is not labeled indicates that no gates are excited between nodes connected via the edge.

Furthermore, in one embodiment of the present disclosure, the qubit architecture corresponds to a dynamic quantum circuit represented as a three-dimensional circuit topology.

Additionally, in one embodiment of the present disclosure, the circuit instructions are highlighted within a light cone.

Other forms of the embodiments of the method described above are in a system and in a computer program product.

Accordingly, embodiments of the present disclosure enable the visualization of information regarding both a quantum circuit and a quantum device upon which the quantum circuit is executed. As a result, quantum computationalists will be able to design transpilation, mapping, optimization, and circuit synthesis strategies that include all of the important characteristics of the quantum circuit and the quantum device upon which the quantum circuit is executed.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for visualizing information regarding both the quantum circuit and the quantum device upon which it is executed in accordance with an embodiment of the present disclosure;

FIG. 3 illustrates a visualization of the quantum circuit on a quantum device with operational characteristics in accordance with an embodiment of the present disclosure;

FIG. 4 illustrates the device connectivity of the dynamic quantum circuit which is represented as a three-dimensional circuit topology which is propagated along a time axis in accordance with an embodiment of the present disclosure;

FIG. 5A illustrates that the gate or layer operations in dynamic quantum circuits can vary depending on the outcome of the measurements in a preceding layer in accordance with an embodiment of the present disclosure;

FIG. 5B illustrates visualizing conditional operations by navigating various possible outcomes in accordance with an embodiment of the present disclosure;

FIG. 6 illustrates an alternative visualization generated by the displaying engine which enables navigating conditional logic in dynamic quantum circuits in accordance with an embodiment of the present disclosure;

FIGS. 7A-7C illustrate highlighting circuit instructions within a light cone in accordance with an embodiment of the present disclosure;

FIG. 8 illustrates an embodiment of the present disclosure of the hardware configuration of the classical computer which is representative of a hardware environment for practicing the present disclosure; and

FIG. 9 is a flowchart of a method for visualizing information regarding both a quantum circuit and a quantum device upon which the quantum circuit is executed in accordance with an embodiment of the present disclosure.

### DETAILED DESCRIPTION

In one embodiment of the present disclosure, a method for visualizing information regarding both a quantum circuit and a quantum device comprises displaying a qubit architecture of the quantum circuit depicting operational characteristics of the quantum device. The method further comprises displaying one or more images of the qubit architecture of the quantum circuit propagated along a third dimension axis across one or more circuit layers plotted with circuit instructions.

In this manner, information regarding both a quantum circuit and a quantum device upon which the quantum circuit is executed can be visualized. As a result, quantum computationalists will be able to design transpilation, mapping, optimization, and circuit synthesis strategies that include all of the important characteristics of the quantum circuit and the quantum device upon which the quantum circuit is executed.

Furthermore, in one embodiment of the present disclosure, the qubit architecture of the quantum circuit depicting operational characteristics of the quantum device is displayed in a first circuit layer.

In this manner, information about the quantum device's operational characteristics can be plotted.

Additionally, in one embodiment of the present disclosure, the method further comprises displaying an image of the qubit architecture of the quantum circuit in a final circuit layer depicting measurement information about the quantum circuit and the quantum device.

In this manner, measurement information regarding both a quantum circuit and a quantum device upon which the quantum circuit is executed can be visualized concurrently.

Furthermore, in one embodiment of the present disclosure, the nodes in the final circuit layer are labeled to indicate measurement basis information, where edges in the final circuit layer are labeled to indicate measurement error information.

In this manner, measurement information regarding both a quantum circuit and a quantum device upon which the quantum circuit is executed can be visualized concurrently.

Additionally, in one embodiment of the present disclosure, the nodes of the qubit architecture of the quantum circuit are qubits, where edges of the qubit architecture of the quantum circuit indicate connectivity between the qubits.

In this manner, important characteristics of the quantum circuit can be visualized.

Furthermore, in one embodiment of the present disclosure, one or more of the nodes are labeled to indicate a property of the qubits, where one or more of the edges are labeled to indicate a property of gates.

In this manner, important characteristics of the quantum circuit can be visualized.

Additionally, in one embodiment of the present disclosure, an edge that is not labeled indicates that no gates are excited between nodes connected via the edge.

In this manner, important characteristics of the quantum circuit can be visualized.

Furthermore, in one embodiment of the present disclosure, the qubit architecture corresponds to a dynamic quantum circuit represented as a three-dimensional circuit topology.

In this manner, the device connectivity of the dynamic quantum circuit can be visualized, including the ability to have the quantum circuit's layers being visualized over time, such as by scrolling through the quantum circuit's layers via a layer scroll.

Additionally, in one embodiment of the present disclosure, the circuit instructions are highlighted within a light cone.

In this manner, circuit instructions may be highlighted within the light cone to assist the user in determining the computational complexity or the effect of noise spreading through the system.

Other forms of the embodiments of the method described above are in a system and in a computer program product.

As stated above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation and quantum error correction techniques have been developed. Quantum error mitigation refers to mitigating computation errors while keeping the hardware load to a minimum. Quantum error correction refers to a set of techniques used in quantum computing to protect quantum information from errors due to decoherence and other quantum noise.

However, such techniques involves overhead, which should be minimized. As a result, quantum computations should be executed with minimal noise to minimize the overhead of quantum error mitigation and quantum error correction techniques.

Various strategies exist for executing quantum computations with minimal noise. One strategy is to map a quantum circuit to a particular quantum device, typically constrained only by the native connectivity and the gate set.

Another strategy is to utilize an algorithm, such as “mapomatic,” where a quantum device is mapped to a particular quantum circuit, typically based on the operational characteristics of the quantum device (e.g., two-qubit gates, measurement errors, etc.).

Developing such complex strategies requires tools for visualization and manipulation, but the challenge is that such tools do not exist. For example, there is not currently a means for visualizing quantum circuits on a quantum device with operational characteristics. Instead, at best, operational characteristics may be shown with quantum circuits on nearest-neighbor one-dimensional (1D) chains.

As a result, there is not currently a means for effectively visualizing information about both the quantum circuit and the quantum device upon which it is executed.

The embodiments of the present disclosure provide the means for visualizing information regarding both a quantum circuit and a quantum device upon which the quantum circuit is executed by displaying a qubit architecture (e.g., two-dimensional qubit architecture) of the quantum circuit depicting operational characteristics of the quantum device in a first circuit layer. Furthermore, one or more images of the qubit architecture of the quantum circuit are displayed as being propagated along a third dimension axis across one or more circuit layers plotted with circuit instructions. Additionally, an image of the qubit architecture of the quantum circuit is displayed in a final circuit layer depicting measurement information about the quantum circuit and the quantum device. In this manner, information about both the quantum circuit and the quantum device upon which it is executed may be effectively visualized. These and other features will be discussed in further detail below.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

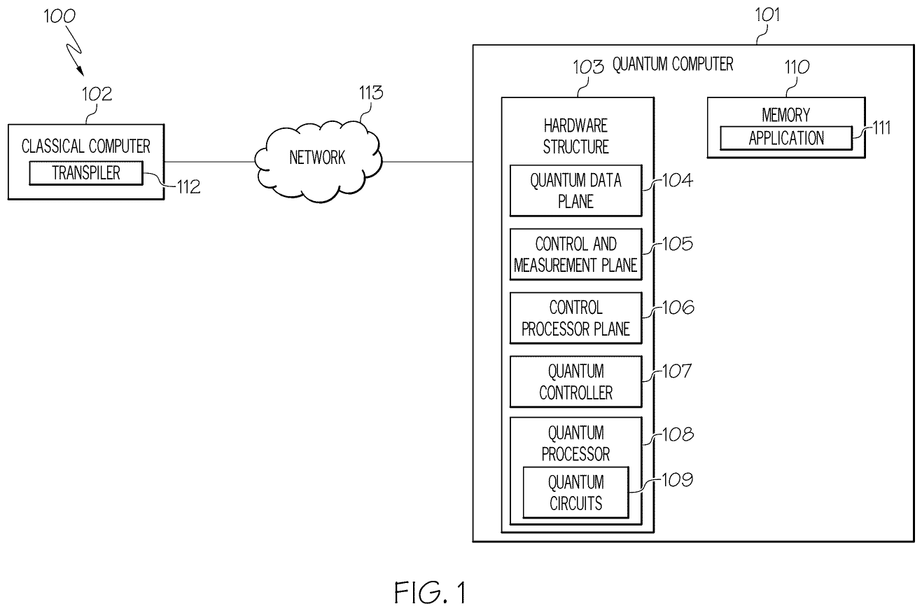

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to visualize information regarding both the quantum circuit and the quantum device upon which it is executed.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off”′ states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX/2}, which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

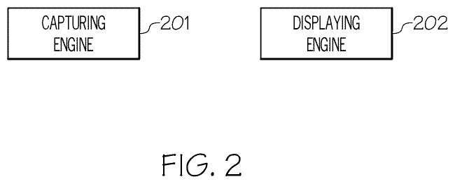

In one embodiment, memory 110 stores an application 111 that may be configured to implement one or more of the methods described herein in accordance with one or more embodiments. For example, application 111 may implement a program for visualizing information regarding both the quantum circuit and the quantum device upon which it is executed as discussed further below in connection with FIGS. 2-4, 5A-5B, 6, 7A-7C and 9. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

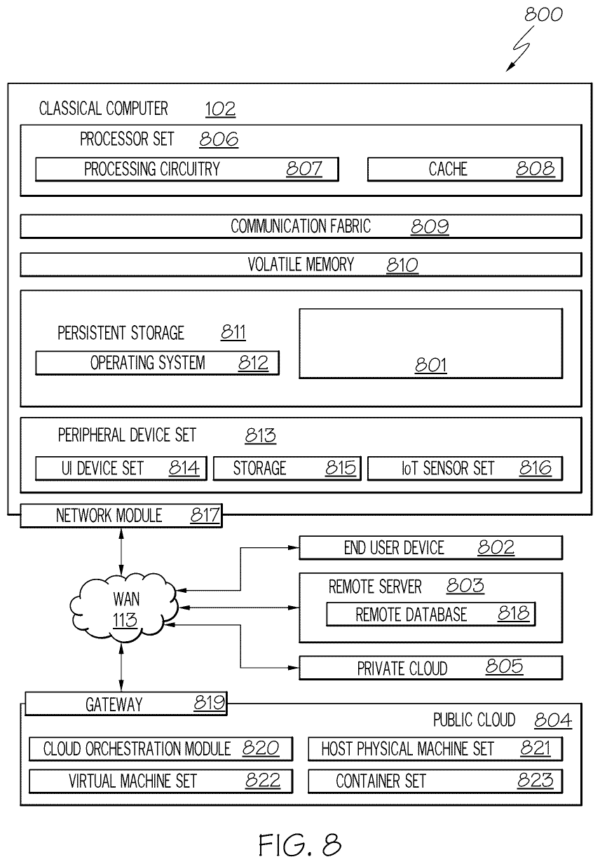

Furthermore, classical computer 102 is configured to visualize information regarding both the quantum circuit and the quantum device upon which it is executed as discussed further below in connection with FIGS. 2-4, 5A-5B, 6, 7A-7C and 9. A description of the software components of classical computer 102 is provided below in connection with FIG. 2 and a description of the hardware configuration of classical computer 102 is provided further below in connection with FIG. 8.

System 100 is not to be limited in scope to any one particular network architecture. System 100 may include any number of quantum computers 101, classical computers 102, and networks 113.

A discussion regarding the software components used by classical computer 102 for visualizing information regarding both the quantum circuit and the quantum device upon which it is executed is provided below in connection with FIG. 2.

FIG. 2 is a diagram of the software components of classical computer 102 (FIG. 1) for visualizing information regarding both the quantum circuit and the quantum device upon which it is executed in accordance with an embodiment of the present disclosure.

Referring to FIG. 2, in conjunction with FIG. 1, classical computer 102 includes capturing engine 201 configured to capture the information that needs to be visualized concerning the quantum circuit and the quantum device upon which the quantum circuit is executed.

In one embodiment, information, such as operational characteristics (e.g., measurement basis, qubit characteristics) of the quantum circuit (e.g., quantum circuit 109) are obtained from a simulator simulating the quantum circuit. For example, a simulator may be created using the Aer module of Qiskit®, which executes the quantum circuit. The measurement results may then be obtained from capturing engine 201.

In one embodiment, measurements of the quantum circuit (e.g., quantum circuit), such as the measurements of the qubits, may be obtained by capturing engine 201 using a measurement function (e.g., circuit.measure( )) from Qiskit® after the quantum circuit is simulated using a simulator (e.g., qasm_simulator in Qiskit®).

In one embodiment, information, such as operational characteristics (e.g., measurement errors, gate errors) of the quantum device (e.g., quantum computer 101) upon which the quantum circuit is executed, are obtained from various software tools, such as IBM Quantum™ Platform, Cirq®, etc.

Upon capturing the information that needs to be visualized concerning the quantum circuit and the quantum device upon which the quantum circuit is executed, displaying engine 202 of classical computer 102 is configured to visualize the information regarding both the quantum circuit (e.g., quantum circuit 109) and the quantum device (e.g., quantum computer 101) upon which the quantum circuit is executed.

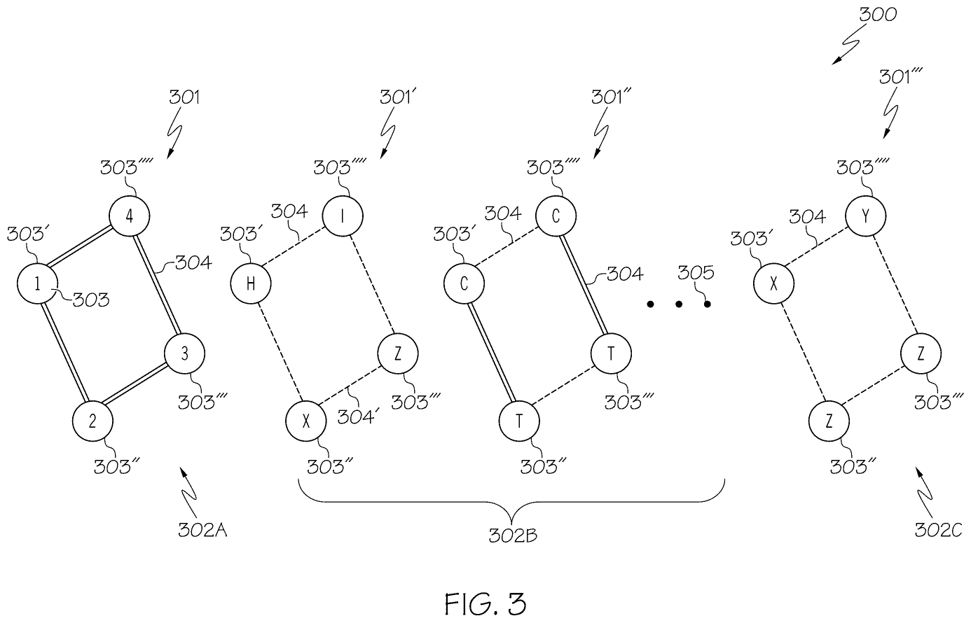

In one embodiment, displaying engine 202 displays a qubit architecture (e.g., two-dimensional qubit architecture) of the quantum circuit depicting operational characteristics of the quantum device in a first circuit layer. Furthermore, displaying engine 202 displays one or more images of the qubit architecture of the quantum circuit that are propagated along a third dimension axis across one or more circuit layers plotted with circuit instructions. Additionally, displaying engine 202 displays an image of the qubit architecture in a final circuit layer depicting measurement information about the quantum circuit and the quantum device. An illustration of such a visualization is provided in FIG. 3.

FIG. 3 illustrates a visualization 300 of the quantum circuit on a quantum device with operational characteristics in accordance with an embodiment of the present disclosure.

Referring to FIG. 3, in conjunction with FIGS. 1-2, displaying engine 202 displays a visualization 300 of the quantum circuit (e.g., quantum circuit 109) on a quantum device (e.g., quantum computer 101) with operational characteristics. In such a visualization 300, a qubit architecture 301 (e.g., two-dimensional qubit architecture) of the quantum circuit (e.g., quantum circuit 109) is depicted in a first circuit layer 302A. A quantum circuit, as used herein, refers to a model for quantum computation in which a computation is a sequence of quantum logic gates, measurements, initializations of qubits to known values and possibly other actions. A qubit architecture, as used herein, refers to an illustration of the interconnection between the qubits.

In one embodiment, qubit architecture 301 includes nodes 303, which represent the qubits. In one embodiment, such nodes 303 are labeled to indicate a property of the qubit, such as the qubit number (e.g., numbered 1-4 in nodes 303′, 303″, 303′″, and 303″″, respectively, in FIG. 3) as illustrated in qubit architecture 301.

Furthermore, in one embodiment, nodes 303 may be labeled to indicate a property of the qubit, such as the T1 time, T2 time, etc. via color or text information.

In one embodiment, qubit architecture 301 includes edges 304 which indicate connectivity between the connected qubits which are represented by the connected nodes 303. In one embodiment, edges 304 may be labeled to indicate a property of gates, such as multi-qubit gates. For example, edges 304 may be labeled to indicate operational characteristics, such as gate error, gate time, etc. For instance, an edge 304 may indicate an operational characteristic of a multi-qubit gate (component of the quantum circuit), such as the two-qubit gate error. In one embodiment, such operational characteristics may be indicated via color or text information. For example, the shade of the color may indicate the extent of the error, such as a gate error.

In one embodiment, if edge 304 is not labeled, then such an edge 304 indicates that no gates are excited between the nodes 303 connected via that edge 304.

In one embodiment, nodes 303 are labeled to include qubit information, such as the T1 time, T2 time, etc. of a single-qubit. In one embodiment, such information may be indicated via color or text information.

Furthermore, as shown in FIG. 3, displaying engine 202 displays one or more images of qubit architecture 301, such as qubit architectures 301′, 301″, propagated along a third dimension axis corresponding to a time axis 305 across one or more circuit layers 302B with circuit instructions. Time axis 305, as used herein, refers to a representation of time as a parameter in classical mechanics.

An “image,” as used herein, refers to a visual representation of qubit architecture 301 with an identical architecture (e.g., same number of qubits represented as nodes 303 arranged in the same fashion) that is subjected to different circuit instructions. A “circuit instruction,” as used herein, refers to a sequence of quantum gates, measurements, and other actions that act on the qubits. For example, such circuit instructions may correspond to a sequence of quantum gates, such as H (Hadamard), X (Pauli-X), Z (Pauli-Z) and I (Identity) gates, which are shown in nodes 303 associated with the qubit numbers of 1-4, respectively, for qubit architecture 301′.

In another example, such circuit instructions may correspond to a sequence of quantum gates, such as C (combined gate, such as combined Pauli-X and Pauli-Y gates), T (non-Clifford gate), T, and C gates, which are shown in nodes 303 associated with the qubit numbers of 1-4, respectively, for qubit architecture 301″.

While FIG. 3 illustrates two circuit layers 302B, one or more images of qubit architecture 301 may be propagated along time axis 305 across any number of circuit layers 302 with circuit instructions.

Furthermore, as shown in the one or more images of qubit architecture 301, such as qubit architectures 301′, 301″, that are propagated along time axis 305 across one or more circuit layers 302B with circuit instructions, edges 304 of such qubit architectures 301′, 301″ may be labeled to indicate a property of gates, such as multi-qubit gates. For example, edges 304 may be labeled to indicate operational characteristics, such as gate error, gate time, etc. For instance, an edge 304 may indicate an operational characteristic of a multi-qubit gate (component of the quantum circuit), such as the two-qubit gate error. In one embodiment, such operational characteristics may be indicated via color or text information. For example, the shade of the color may indicate the extent of the error, such as a gate error.

In one embodiment, if edge 304 is not labeled, then such an edge 304 indicates that no gates are excited between the nodes 303 connected via that edge 304 as illustrated by edge 304′.

Furthermore, as illustrated in FIG. 3, displaying engine 202 displays an image of qubit architecture 301, such as qubit architecture 301′″, in a final circuit layer 302C depicting measurement information about the quantum circuit and the quantum device. For example, nodes 303 in final circuit layer 302C are labeled to indicate measurement basis information, such as measuring in the X basis, the Z-basis, the Z-basis and the Y-basis as labeled in nodes 303 associated with the qubit numbers of 1-4, respectively, for qubit architecture 301′″. Circuit layers 302A-302C may collectively or individually be referred to as circuit layers 302 or circuit layer 302, respectively.

Additionally, in one embodiment, edges 304 in final circuit layer 302C indicate measurement error information (e.g., crosstalk) from the quantum device (e.g., quantum computer 101). In one embodiment, such information may be indicated via color or text information.

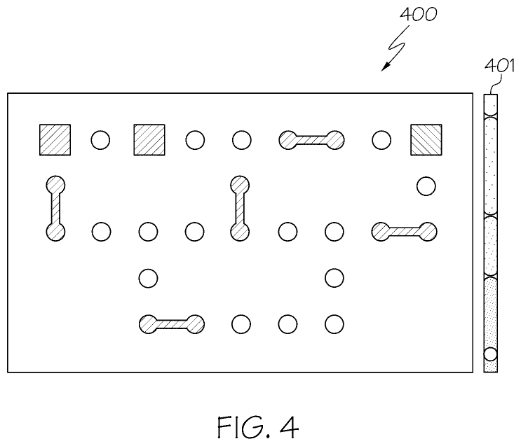

In one embodiment, qubit architecture 301, as well as the images of qubit architecture 301, such as qubit architectures 301′, 301″, and 301′″, are represented as a two-dimension structure. In one embodiment, displaying engine 202 displays a qubit architecture as a three-dimensional structure, which is propagated along a time axis, similar to axis 305. For example, a dynamic quantum circuit may be represented as a three-dimensional circuit topology as shown in FIG. 4.

Referring to FIG. 4, FIG. 4 illustrates the device connectivity of dynamic quantum circuit 400 which is represented as a three-dimensional circuit topology which is propagated along a time axis, such as axis 305 of FIG. 3, in accordance with an embodiment of the present disclosure. In one embodiment, the quantum circuit's layers can be visualized over time by scrolling through the quantum circuit's layers via a layer scroll 401.

In one embodiment, layer scroll 401 includes color tags for depicting the various tags of the algorithms.

In one embodiment, at each layer, the depicted dynamic quantum circuit 400 includes the layer number and optional layer information, such as the estimated layer fidelity.

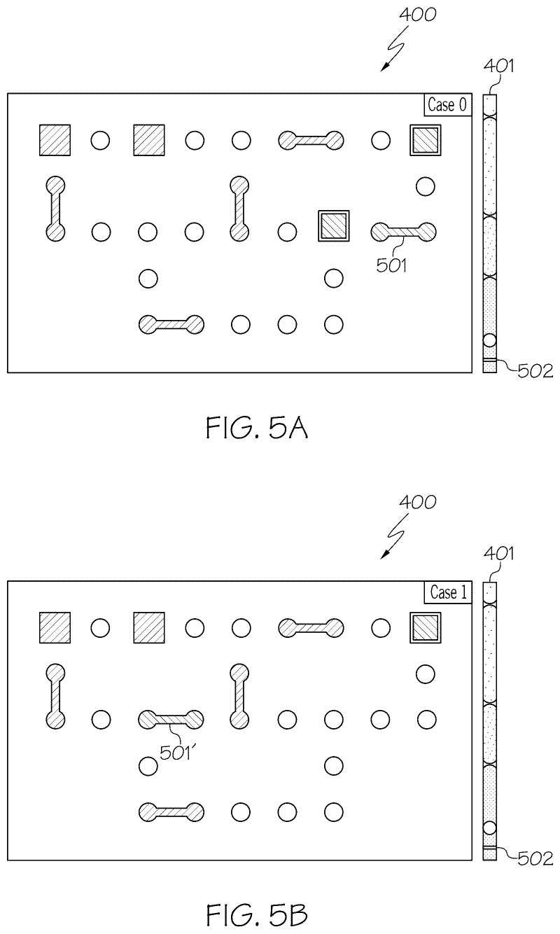

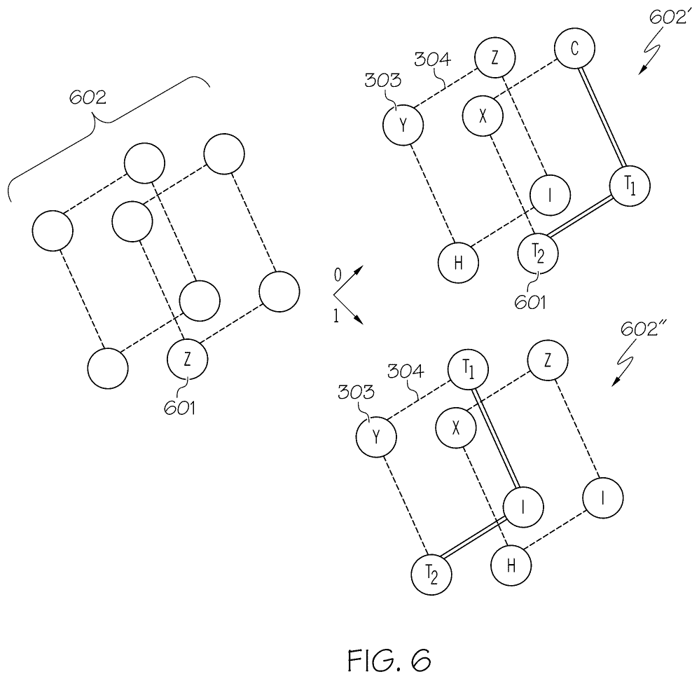

In one embodiment, the visualizations generated by displaying engine 202 enable navigating conditional logic in dynamic quantum circuits as shown in FIGS. 5A-5B.

Referring to FIG. 5A, FIG. 5A illustrates that the gate or layer operations in dynamic quantum circuits, such as the depicted dynamic quantum circuit 400, can vary depending on the outcome of the measurements in a preceding layer in accordance with an embodiment of the present disclosure.

For example, as shown in FIG. 5A, conditional gate 501 has a link to a measurement layer, which is highlighted 502 in layer scroll 401.

Referring to FIG. 5B, FIG. 5B illustrates visualizing conditional operations by navigating various possible outcomes in accordance with an embodiment of the present disclosure.

For example, the gate or layer operation depicted in FIG. 5A varies based on the outcome of the measurements in a preceding layer as shown by the repositioning of conditional gate 501, represented as conditional gate 501′ as shown in FIG. 5B.

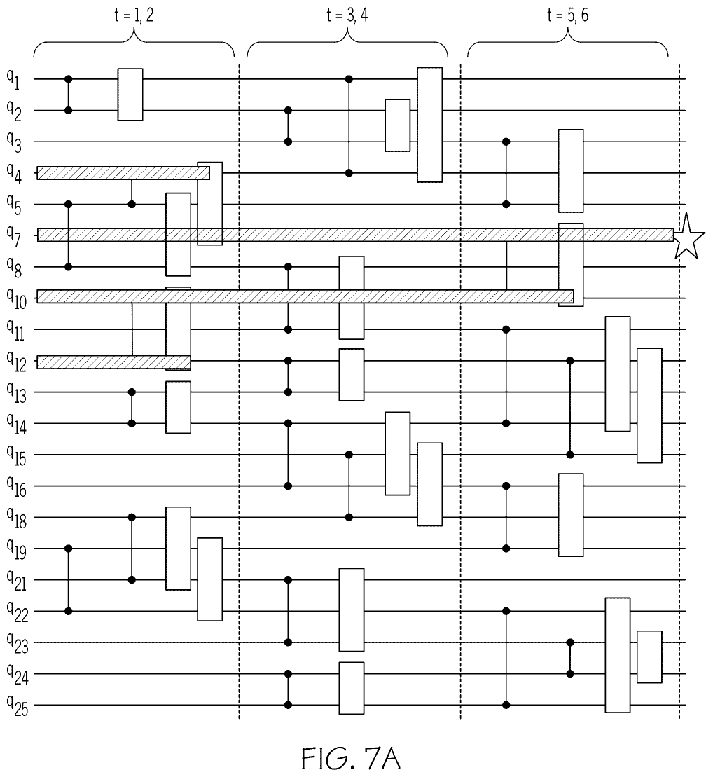

FIG. 6 illustrates an alternative visualization generated by displaying engine 202 which enables navigating conditional logic in dynamic quantum circuits in accordance with an embodiment of the present disclosure.

Referring to FIG. 6, the gate or layer operations can vary depending on the outcome of the measurements in a preceding layer. For example, based on the outcome of the measurement of the Z-gate 601 of dynamic quantum circuit 602, displaying engine 202 dynamically generates images of dynamic quantum circuit 602, represented as dynamic quantum circuits, 602′, 602″, with information labeled in nodes 303 and edges 304 as previously discussed, based on the outcome of the measurement of the Z-gate 601, such as 0 or 1, respectively.

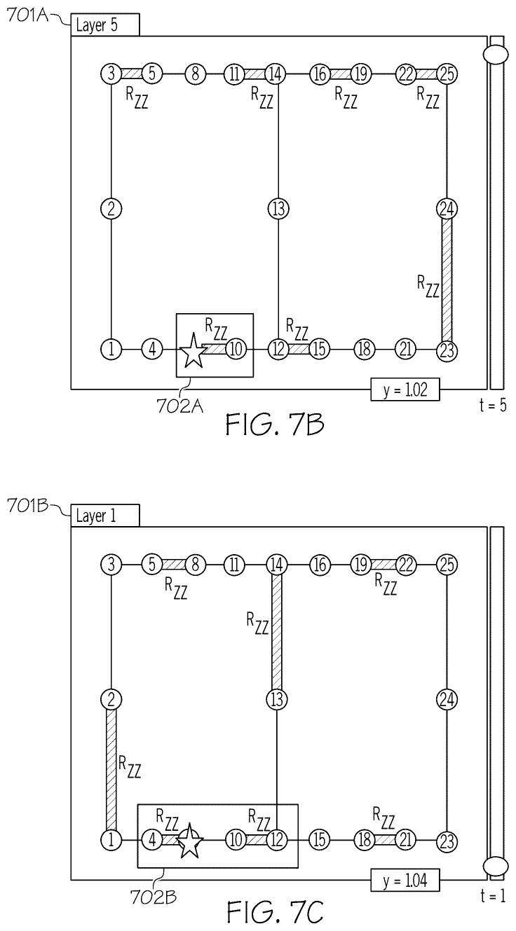

Furthermore, in one embodiment, displaying engine 202 highlights circuit instructions within a light cone as illustrated in FIGS. 7A-7C.

FIGS. 7A-7C illustrate highlighting circuit instructions within a light cone in accordance with an embodiment of the present disclosure.

A light cone of a particular gate or observable may be relevant to determine the computational complexity or the effect of noise spreading through the system. For example, as shown in FIGS. 7A-7C, circuit instructions of circuit layers 5 and 1, 701A-701B, respectively, may be highlighted within light cone 702A-702B, respectively, to assist the user in determining the computational complexity or the effect of noise spreading through the system. Circuit layers 701A-701B may collectively or individually be referred to as circuit layers 701 or circuit layer 701, respectively. Light cones 702A-702B, may collectively or individually be referred to as light cones 702 or light cone 702, respectively. A light cone 702, as used herein, refers to a map of the effects that the circuit operations have on the final observable value.

In this manner, information may be visualized regarding both a quantum circuit and a quantum device upon which the quantum circuit is executed. As a result, quantum computationalists will be able to design transpilation, mapping, optimization, and circuit synthesis strategies that include all of the important characteristics of the quantum circuit and the quantum device upon which the quantum circuit is executed. Furthermore, by visualizing the information regarding both the quantum circuit and the quantum device upon which the quantum circuit is executed in the manner discussed above, the origin of operational characteristics, such as the origin of an error, is easier to understand.

A further description of these and other functions is provided below in connection with the discussion of the method for visualizing information regarding both a quantum circuit and the quantum device upon which it is executed.

Prior to the discussion of the method for visualizing information regarding both a quantum circuit and the quantum device upon which it is executed, a description of the hardware configuration of classical computer 102 (FIG. 1) is provided below in connection with FIG. 8.

Referring now to FIG. 8, in conjunction with FIG. 1, FIG. 8 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code 801 involved in performing the inventive methods, such as visualizing information regarding both a quantum circuit and the quantum device upon which it is executed. In addition to block 801, computing environment 800 includes, for example, classical computer 102, network 113, such as a wide area network (WAN), end user device (EUD) 802, remote server 803, public cloud 804, and private cloud 805. In this embodiment, classical computer 102 includes processor set 806 (including processing circuitry 807 and cache 808), communication fabric 809, volatile memory 810, persistent storage 811 (including operating system 812 and block 801, as identified above), peripheral device set 813 (including user interface (UI) device set 814, storage 815, and Internet of Things (IoT) sensor set 816), and network module 817. Remote server 803 includes remote database 818. Public cloud 804 includes gateway 819, cloud orchestration module 820, host physical machine set 821, virtual machine set 822, and container set 823.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 818. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically classical computer 102, to keep the presentation as simple as possible. Classical computer 102 may be located in a cloud, even though it is not shown in a cloud in FIG. 8. On the other hand, classical computer 102 is not required to be in a cloud except to any extent as may be affirmatively indicated.

Processor set 806 includes one, or more, computer processors of any type now known or to be developed in the future. Processing circuitry 807 may be distributed over multiple packages, for example, multiple, coordinated integrated circuit chips. Processing circuitry 807 may implement multiple processor threads and/or multiple processor cores. Cache 808 is memory that is located in the processor chip package(s) and is typically used for data or code that should be available for rapid access by the threads or cores running on processor set 806. Cache memories are typically organized into multiple levels depending upon relative proximity to the processing circuitry. Alternatively, some, or all, of the cache for the processor set may be located “off chip.” In some computing environments, processor set 806 may be designed for working with qubits and performing quantum computing.

Computer readable program instructions are typically loaded onto classical computer 102 to cause a series of operational steps to be performed by processor set 806 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 808 and the other storage media discussed below. The program instructions, and associated data, are accessed by processor set 806 to control and direct performance of the inventive methods. In computing environment 800, at least some of the instructions for performing the inventive methods may be stored in block 801 in persistent storage 811.

Communication fabric 809 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 810 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 810 is located in a single package and is internal to classical computer 102, but, alternatively or additionally, the volatile memory may be distributed over multiple packages and/or located externally with respect to classical computer 102.

Persistent Storage 811 is any form of non-volatile storage for computers that is now known or to be developed in the future. The non-volatility of this storage means that the stored data is maintained regardless of whether power is being supplied to classical computer 102 and/or directly to persistent storage 811. Persistent storage 811 may be a read only memory (ROM), but typically at least a portion of the persistent storage allows writing of data, deletion of data and re-writing of data. Some familiar forms of persistent storage include magnetic disks and solid state storage devices. Operating system 812 may take several forms, such as various known proprietary operating systems or open source Portable Operating System Interface type operating systems that employ a kernel. The code included in block 801 typically includes at least some of the computer code involved in performing the inventive methods.

Peripheral device set 813 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 814 may include components such as a display screen, speaker, microphone, wearable devices (such as goggles and smart watches), keyboard, mouse, printer, touchpad, game controllers, and haptic devices. Storage 815 is external storage, such as an external hard drive, or insertable storage, such as an SD card. Storage 815 may be persistent and/or volatile. In some embodiments, storage 815 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 816 is made up of sensors that can be used in Internet of Things applications. For example, one sensor may be a thermometer and another sensor may be a motion detector.

Network module 817 is the collection of computer software, hardware, and firmware that allows classical computer 102 to communicate with other computers through WAN 113. Network module 817 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 817 are performed on the same physical hardware device. In other embodiments (for example, embodiments that utilize software-defined networking (SDN)), the control functions and the forwarding functions of network module 817 are performed on physically separate devices, such that the control functions manage several different network hardware devices. Computer readable program instructions for performing the inventive methods can typically be downloaded to classical computer 102 from an external computer or external storage device through a network adapter card or network interface included in network module 817.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 802 is any computer system that is used and controlled by an end user (for example, a customer of an enterprise that operates classical computer 102), and may take any of the forms discussed above in connection with classical computer 102. EUD 802 typically receives helpful and useful data from the operations of classical computer 102. For example, in a hypothetical case where classical computer 102 is designed to provide a recommendation to an end user, this recommendation would typically be communicated from network module 817 of classical computer 102 through WAN 113 to EUD 802. In this way, EUD 802 can display, or otherwise present, the recommendation to an end user. In some embodiments, EUD 802 may be a client device, such as thin client, heavy client, mainframe computer, desktop computer and so on.

Remote server 803 is any computer system that serves at least some data and/or functionality to classical computer 102. Remote server 803 may be controlled and used by the same entity that operates classical computer 102. Remote server 803 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 818 of remote server 803.

Public cloud 804 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 804 is performed by the computer hardware and/or software of cloud orchestration module 820. The computing resources provided by public cloud 804 are typically implemented by virtual computing environments that run on various computers making up the computers of host physical machine set 821, which is the universe of physical computers in and/or available to public cloud 804. The virtual computing environments (VCEs) typically take the form of virtual machines from virtual machine set 822 and/or containers from container set 823. It is understood that these VCEs may be stored as images and may be transferred among and between the various physical machine hosts, either as images or after instantiation of the VCE. Cloud orchestration module 820 manages the transfer and storage of images, deploys new instantiations of VCEs and manages active instantiations of VCE deployments. Gateway 819 is the collection of computer software, hardware, and firmware that allows public cloud 804 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 805 is similar to public cloud 804, except that the computing resources are only available for use by a single enterprise. While private cloud 805 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 804 and private cloud 805 are both part of a larger hybrid cloud.

Block 801 further includes the software components discussed above in connection with FIGS. 2-4, 5A-5B, 6 and 7A-7C to visualize information regarding both the quantum circuit and the quantum device upon which it is executed. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for visualizing information regarding both the quantum circuit and the quantum device upon which it is executed, may be embodied in an application specific integrated circuit.

As stated above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation and quantum error correction techniques have been developed. Quantum error mitigation refers to mitigating computation errors while keeping the hardware load to a minimum. Quantum error correction refers to a set of techniques used in quantum computing to protect quantum information from errors due to decoherence and other quantum noise. However, such techniques involves overhead, which should be minimized. As a result, quantum computations should be executed with minimal noise to minimize the overhead of quantum error mitigation and quantum error correction techniques. Various strategies exist for executing quantum computations with minimal noise. One strategy is to map a quantum circuit to a particular quantum device, typically constrained only by the native connectivity and the gate set. Another strategy is to utilize an algorithm, such as “mapomatic,” where a quantum device is mapped to a particular quantum circuit, typically based on the operational characteristics of the quantum device (e.g., two-qubit gates, measurement errors, etc.). Developing such complex strategies requires tools for visualization and manipulation, but the challenge is that such tools do not exist. For example, there is not currently a means for visualizing quantum circuits on a quantum device with operational characteristics. Instead, at best, operational characteristics may be shown with quantum circuits on nearest-neighbor one-dimensional (1D) chains. As a result, there is not currently a means for effectively visualizing information about both the quantum circuit and the quantum device upon which it is executed.

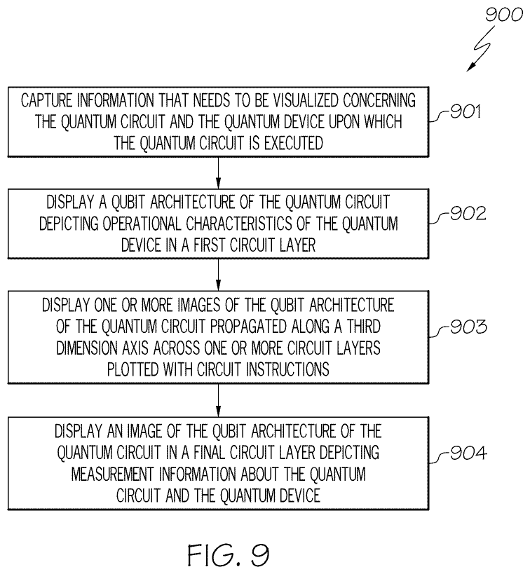

The embodiments of the present disclosure provide the means for visualizing information regarding both a quantum circuit and a quantum device upon which the quantum circuit is executed as discussed below in connection with FIG. 9.

FIG. 9 is a flowchart of a method 900 for visualizing information regarding both a quantum circuit and a quantum device upon which the quantum circuit is executed in accordance with an embodiment of the present disclosure.

Referring to FIG. 9, in conjunction with FIGS. 1-4, 5A-5B, 6, 7A-7C and 8, in step 901, capturing engine 201 of classical computer 102 captures the information that needs to be visualized concerning the quantum circuit (e.g., quantum circuit 109) and the quantum device (e.g., quantum computer 101) upon which the quantum circuit is executed.

As discussed above, in one embodiment, information, such as operational characteristics (e.g., measurement basis, qubit characteristics) of the quantum circuit (e.g., quantum circuit 109) are obtained from a simulator simulating the quantum circuit. For example, a simulator may be created using the Aer module of Qiskit®, which executes the quantum circuit. The measurement results may then be obtained from capturing engine 201.

In one embodiment, measurements of the quantum circuit (e.g., quantum circuit), such as the measurements of the qubits, may be obtained by capturing engine 201 using a measurement function (e.g., circuit.measure( )) from Qiskit® after the quantum circuit is simulated using a simulator (e.g., qasm_simulator in Qiskit®).

In one embodiment, information, such as operational characteristics (e.g., measurement errors, gate errors) of the quantum device (e.g., quantum computer 101) upon which the quantum circuit is executed, are obtained from various software tools, such as IBM Quantum™ Platform, Cirq®, etc.

Upon capturing the information that needs to be visualized concerning the quantum circuit and the quantum device upon which the quantum circuit is executed, displaying engine 202 of classical computer 102 visualizes the information regarding both the quantum circuit (e.g., quantum circuit 109) and the quantum device (e.g., quantum computer 101) upon which the quantum circuit is executed as discussed below in connection with steps 902-904.

In step 902, displaying engine 202 of classical computer 102 displays a qubit architecture (e.g., two-dimensional qubit architecture) of the quantum circuit depicting operational characteristics of the quantum device in a first circuit layer.

In step 903, displaying engine 202 of classical computer 102 displays one or more images of the qubit architecture of the quantum circuit that are propagated along a third dimension axis across one or more circuit layers plotted with circuit instructions.

In step 904, displaying engine 202 of classical computer 102 displays an image of the qubit architecture of the quantum circuit in a final circuit layer depicting measurement information about the quantum circuit and the quantum device.

As stated above, an illustration of the visualization generated by display engine 202 from executing steps 902-904 is provided in FIG. 3.

Referring to FIG. 3, displaying engine 202 displays a visualization 300 of the quantum circuit (e.g., quantum circuit 109) on a quantum device (e.g., quantum computer 101) with operational characteristics. In such a visualization 300, a qubit architecture 301 (e.g., two-dimensional qubit architecture) of the quantum circuit (e.g., quantum circuit 109) is depicted in a first circuit layer 302A. A quantum circuit, as used herein, refers to a model for quantum computation in which a computation is a sequence of quantum logic gates, measurements, initializations of qubits to known values and possibly other actions. A qubit architecture, as used herein, refers to an illustration of the interconnection between the qubits.

In one embodiment, qubit architecture 301 includes nodes 303, which represent the qubits. In one embodiment, such nodes 303 are labeled to indicate a property of the qubit, such as the qubit number (e.g., numbered 1-4 in nodes 303′, 303″, 303′″, and 303″″, respectively, in FIG. 3) as illustrated in qubit architecture 301.

Furthermore, in one embodiment, nodes 303 may be labeled to indicate a property of the qubit, such as the T1 time, T2 time, etc. via color or text information.

In one embodiment, qubit architecture 301 includes edges 304 which indicate connectivity between the connected qubits which are represented by the connected nodes 303. In one embodiment, edges 304 may be labeled to indicate a property of gates, such as multi-qubit gates. For example, edges 304 may be labeled to indicate operational characteristics, such as gate error, gate time, etc. For instance, an edge 304 may indicate an operational characteristic of a multi-qubit gate (component of the quantum circuit), such as the two-qubit gate error. In one embodiment, such operational characteristics may be indicated via color or text information. For example, the shade of the color may indicate the extent of the error, such as a gate error.

In one embodiment, if edge 304 is not labeled, then such an edge 304 indicates that no gates are excited between the nodes 303 connected via that edge 304.

In one embodiment, nodes 303 are labeled to include qubit information, such as the T1 time, T2 time, etc. of a single-qubit. In one embodiment, such information may be indicated via color or text information.

Furthermore, as shown in FIG. 3, displaying engine 202 displays one or more images of qubit architecture 301, such as qubit architectures 301′, 301″, propagated along a third dimension axis corresponding to a time axis 305 across one or more circuit layers 302B with circuit instructions. Time axis 305, as used herein, refers to a representation of time as a parameter in classical mechanics.

An “image,” as used herein, refers to a visual representation of qubit architecture 301 with an identical architecture (e.g., same number of qubits represented as nodes 303 arranged in the same fashion) that is subjected to different circuit instructions. A “circuit instruction,” as used herein, refers to a sequence of quantum gates, measurements, and other actions that act on the qubits. For example, such circuit instructions may correspond to a sequence of quantum gates, such as H (Hadamard), X (Pauli-X), Z (Pauli-Z) and I (Identity) gates, which are shown in nodes 303 associated with the qubit numbers of 1-4, respectively, for qubit architecture 301′.

In another example, such circuit instructions may correspond to a sequence of quantum gates, such as C (combined gate, such as combined Pauli-X and Pauli-Y gates), T (non-Clifford gate), T, and C gates, which are shown in nodes 303 associated with the qubit numbers of 1-4, respectively, for qubit architecture 301″.

While FIG. 3 illustrates two circuit layers 302B, one or more images of qubit architecture 301 may be propagated along time axis 305 across any number of circuit layers 302 with circuit instructions.

Furthermore, as shown in the one or more images of qubit architecture 301, such as qubit architectures 301′, 301″, that are propagated along time axis 305 across one or more circuit layers 302B with circuit instructions, edges 304 of such qubit architectures 301′, 301″ may be labeled to indicate a property of gates, such as multi-qubit gates. For example, edges 304 may be labeled to indicate operational characteristics, such as gate error, gate time, etc. For instance, an edge 304 may indicate an operational characteristic of a multi-qubit gate (component of the quantum circuit), such as the two-qubit gate error. In one embodiment, such operational characteristics may be indicated via color or text information. For example, the shade of the color may indicate the extent of the error, such as a gate error.

In one embodiment, if edge 304 is not labeled, then such an edge 304 indicates that no gates are excited between the nodes 303 connected via that edge 304 as illustrated by edge 304″.

Furthermore, as illustrated in FIG. 3, displaying engine 202 displays an image of qubit architecture 301, such as qubit architecture 301′″, in a final circuit layer 302C depicting measurement information about the quantum circuit and the quantum device. For example, nodes 303 in final circuit layer 302C are labeled to indicate measurement basis information, such as measuring in the X basis, the Z-basis, the Z-basis and the Y-basis as labeled in nodes 303 associated with the qubit numbers of 1-4, respectively, for qubit architecture 301″″.

Additionally, in one embodiment, edges 304 in final circuit layer 302C indicate measurement error information (e.g., crosstalk) from the quantum device (e.g., quantum computer 101). In one embodiment, such information may be indicated via color or text information.

In one embodiment, qubit architecture 301, as well as the images of qubit architecture 301, such as qubit architectures 301′, 301″, and 301′″, are represented as a two-dimension structure. In one embodiment, displaying engine 202 displays a qubit architecture as a three-dimensional structure, which is propagated along a time axis, similar to axis 305. For example, a dynamic quantum circuit may be represented as a three-dimensional circuit topology as shown in FIG. 4.

Referring to FIG. 4, in one embodiment, the quantum circuit's layers can be visualized over time by scrolling through the quantum circuit's layers via a layer scroll 401.

In one embodiment, layer scroll 401 includes color tags for depicting the various tags of the algorithms.

In one embodiment, at each layer, the depicted dynamic quantum circuit 400 includes the layer number and optional layer information, such as the estimated layer fidelity.

In one embodiment, the visualizations generated by displaying engine 202 enable navigating conditional logic in dynamic quantum circuits as shown in FIGS. 5A-5B.

For example, as shown in FIG. 5A, conditional gate 501 has a link to a measurement layer, which is highlighted 502 in layer scroll 401.

In another example, the gate or layer operation depicted in FIG. 5A varies based on the outcome of the measurements in a preceding layer as shown by the repositioning of conditional gate 501, represented as conditional gate 501′ as shown in FIG. 5B.

Referring to FIG. 6, the gate or layer operations can vary depending on the outcome of the measurements in a preceding layer. For example, based on the outcome of the measurement of the Z-gate 601 of dynamic quantum circuit 602, displaying engine 202 dynamically generates images of dynamic quantum circuit 602, represented as dynamic quantum circuits, 602′, 602″, with information labeled in nodes 303 and edges 304 as previously discussed, based on the outcome of the measurement of the Z-gate 601, such as 0 or 1, respectively.

Furthermore, in one embodiment, displaying engine 202 highlights circuit instructions within a light cone as illustrated in FIGS. 7A-7C.

Referring to FIGS. 7A-7C, a light cone of a particular gate or observable may be relevant to determine the computational complexity or the effect of noise spreading through the system. For example, as shown in FIGS. 7A-7C, circuit instructions of circuit layers 5 and 1, 701A-701B, respectively, may be highlighted within light cone 702A-702B, respectively, to assist the user in determining the computational complexity or the effect of noise spreading through the system. A light cone 702, as used herein, refers to a map of the effects that the circuit operations have on the final observable value.

In this manner, information may be visualized regarding both a quantum circuit and a quantum device upon which the quantum circuit is executed. As a result, quantum computationalists will be able to design transpilation, mapping, optimization, and circuit synthesis strategies that include all of the important characteristics of the quantum circuit and the quantum device upon which the quantum circuit is executed. Furthermore, by visualizing the information regarding both a quantum circuit and the quantum device upon which the quantum circuit is executed in the manner discussed above, the origin of operational characteristics, such as the origin of an error, is easier to understand.

Furthermore, the principles of the present disclosure improve the technology or technical field involving quantum visualization tools.

As discussed above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation and quantum error correction techniques have been developed. Quantum error mitigation refers to mitigating computation errors while keeping the hardware load to a minimum. Quantum error correction refers to a set of techniques used in quantum computing to protect quantum information from errors due to decoherence and other quantum noise. However, such techniques involves overhead, which should be minimized. As a result, quantum computations should be executed with minimal noise to minimize the overhead of quantum error mitigation and quantum error correction techniques. Various strategies exist for executing quantum computations with minimal noise. One strategy is to map a quantum circuit to a particular quantum device, typically constrained only by the native connectivity and the gate set. Another strategy is to utilize an algorithm, such as “mapomatic,” where a quantum device is mapped to a particular quantum circuit, typically based on the operational characteristics of the quantum device (e.g., two-qubit gates, measurement errors, etc.). Developing such complex strategies requires tools for visualization and manipulation, but the challenge is that such tools do not exist. For example, there is not currently a means for visualizing quantum circuits on a quantum device with operational characteristics. Instead, at best, operational characteristics may be shown with quantum circuits on nearest-neighbor one-dimensional (1D) chains. As a result, there is not currently a means for effectively visualizing information about both the quantum circuit and the quantum device upon which it is executed.

Embodiments of the present disclosure improve such technology by displaying a qubit architecture (e.g., two-dimensional qubit architecture) of the quantum circuit depicting operational characteristics of the quantum device in a first circuit layer. Furthermore, one or more images of the qubit architecture of the quantum circuit are displayed as being propagated along a third dimension axis across one or more circuit layers plotted with circuit instructions. Additionally, an image of the qubit architecture of the quantum circuit is displayed in a final circuit layer depicting measurement information about the quantum circuit and the quantum device. In this manner, information about both the quantum circuit and the quantum device upon which it is executed may be effectively visualized. Furthermore, in this manner, there is an improvement in the technical field involving quantum visualization tools.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for visualizing information regarding both a quantum circuit and a quantum device, the method comprising:
displaying a qubit architecture of said quantum circuit depicting operational characteristics of said quantum device; and
displaying one or more images of said qubit architecture of said quantum circuit propagated along a third dimension axis across one or more circuit layers plotted with circuit instructions.

2. The method as recited in claim 1, wherein said qubit architecture of said quantum circuit depicting operational characteristics of said quantum device is displayed in a first circuit layer.

3. The method as recited in claim 2 further comprising:
displaying an image of said qubit architecture of said quantum circuit in a final circuit layer depicting measurement information about said quantum circuit and said quantum device.

4. The method as recited in claim 3, wherein nodes in said final circuit layer are labeled to indicate measurement basis information, wherein edges in said final circuit layer are labeled to indicate measurement error information.

5. The method as recited in claim 1, wherein nodes of said qubit architecture of said quantum circuit are qubits, wherein edges of said qubit architecture of said quantum circuit indicate connectivity between said qubits.

6. The method as recited in claim 5, wherein one or more of said nodes are labeled to indicate a property of said qubits, wherein one or more of said edges are labeled to indicate a property of gates.

7. The method as recited in claim 6, wherein an edge that is not labeled indicates that no gates are excited between nodes connected via said edge.

8. The method as recited in claim 1, wherein said qubit architecture corresponds to a dynamic quantum circuit represented as a three-dimensional circuit topology.

9. The method as recited in claim 1, wherein said circuit instructions are highlighted within a light cone.

10. A computer program product for visualizing information regarding both a quantum circuit and a quantum device, the computer program product comprising one or more computer readable storage mediums having program code embodied therewith, the program code comprising programming instructions for:
displaying a qubit architecture of said quantum circuit depicting operational characteristics of said quantum device; and
displaying one or more images of said qubit architecture of said quantum circuit propagated along a third dimension axis across one or more circuit layers plotted with circuit instructions.

11. The computer program product as recited in claim 10, wherein said qubit architecture of said quantum circuit depicting operational characteristics of said quantum device is displayed in a first circuit layer.

12. The computer program product as recited in claim 11, wherein the program code further comprises the programming instructions for:
displaying an image of said qubit architecture of said quantum circuit in a final circuit layer depicting measurement information about said quantum circuit and said quantum device.

13. The computer program product as recited in claim 12, wherein nodes in said final circuit layer are labeled to indicate measurement basis information, wherein edges in said final circuit layer are labeled to indicate measurement error information.

14. The computer program product as recited in claim 10, wherein nodes of said qubit architecture of said quantum circuit are qubits, wherein edges of said qubit architecture of said quantum circuit indicate connectivity between said qubits.

15. The computer program product as recited in claim 14, wherein one or more of said nodes are labeled to indicate a property of said qubits, wherein one or more of said edges are labeled to indicate a property of gates.

16. The computer program product as recited in claim 15, wherein an edge that is not labeled indicates that no gates are excited between nodes connected via said edge.

17. The computer program product as recited in claim 10, wherein said qubit architecture corresponds to a dynamic quantum circuit represented as a three-dimensional circuit topology.

18. The computer program product as recited in claim 10, wherein said circuit instructions are highlighted within a light cone.

19. A system, comprising:
a memory for storing a computer program for mapping a quantum circuit to a quantum processor; and
a processor connected to said memory, wherein said processor is configured to execute program instructions of the computer program comprising:
displaying a qubit architecture of said quantum circuit depicting operational characteristics of said quantum device; and
displaying one or more images of said qubit architecture of said quantum circuit propagated along a third dimension axis across one or more circuit layers plotted with circuit instructions.

20. The system as recited in claim 19, wherein the program instructions of the computer program further comprise:
displaying an image of said qubit architecture of said quantum circuit in a final circuit layer depicting measurement information about said quantum circuit and said quantum device.
